(19) United States
(12) Patent Application Publication
(10) Pub. No.: US 2003/0010251 A1
(43) Pub. Date: Jan. 16, 2003

(54) Ink compositions involving near-infrared absorber dyes and use in ink jet printing devices

(76) Inventors: Nicole M. Woosman, New Milford, PA (US); Susan R. Loehr, Clarks Summit, PA (US); Robert A. Sallavanti, Dalton, PA (US)

Correspondence Address: KEUSEY, TUTUNJIAN & BITETTO, P.C., 14 VANDERVENTER AVENUE, SUITE 128, PORT WASHINGTON, NY, 11050, US

(21) Appl. No.: 09/892,158

(22) Filed: Jun. 26, 2001

(51) Int. Cl. C09D 11/00

(52) U.S. Cl. 106/31.27; 106/31.32; 106/31.58; 106/31.43

(57) ABSTRACT

An ink composition including a near infrared absorbing dye that converts absorbed near infrared radiation into heat without fluorescing significantly and a substantially non-aqueous, organic solvent system. The dye is a tetrakis (dialkylaminophenyl) aminium dye coupled with one anion, a cyanine or a squarylium. The non-aqueous, organic solvent system includes an alcohol, for example, a diacetone alcohol, 1-methoxy-2-propanol, or combinations thereof The method of treating thermoplastic according to the invention includes (a) providing a near infrared absorbing dye that converts absorbed NIR radiation into heat without fluorescing significantly; (b) dissolving the dye into a substantially non-aqueous, organic solvent to form an ink composition; and (c) contacting a thermoplastic part with the ink composition. The contacting step may include painting, dry-burnishing, dip-coating, spraying, printing, and particularly ink jet printing. Examples of thermoplastic materials are polyesters, polyamides, polyolefins, polyurethanes and polycarbonates.

### BACKGROUND OF THE INVENTION

1. Field of the Invention

The invention relates to ink compositions containing near infrared (NIR) dyes dissolved in non-aqueous solvent systems for application onto polymeric substrates using commonly available industrial techniques, particularly ink jet printing.

2. The Prior Art

Infrared absorbing dyes have been used extensively in optical scanning applications where the dyes are selected for their ability to fluoresce to a significant degree. The following listing of compounds is exemplary:

U.S. Pat. No. 4,892,584 discloses metallized azo dyes.

U.S. Pat. No. 5,093,147 discloses DTTCI, DNTTCI, HDITCI, IR-125, DDTTCI, IR-140. DDCI-4 and IR-132.

U.S. Pat. No. 5,837,042 discloses rare earth metal chelates.

U.S. Pat. No. 5,990,197 discloses polyester with phthalocyanines, naphthalocyanines, or squarines copolymerized therein.

U.S. Pat. No. 6,149,719 discloses an uncomplexed metal phthalocyanine.

In other industrial applications, like through transmission NIR laser welding, the dye is expected to efficiently convert absorbed radiation into localized heat via vibrational relaxation rather than releasing the energy via fluorescence. However, the prior art solvent systems were incompatible with the dyes of the inventions because (i) most solvents were aqueous and the presence of water in any significant degree is an anathema to the dyes and (ii) most systems incorporated resins, binders or other additives to adjust viscosity. While these additives did not affect optical scanning applications, they did alter the mechanical and thermal properties at the dye layer thus interfering with the efficient production of localized heat.

Accordingly, there is a need for NIR dyes incorporated into ink formulations that are suitable for the noted industrial applications. The solvent systems must be compatible with the dyes and allow the dyes to be applied to different substrates by a variety of methods. For high speed commercial printing, especially ink jet printing, there is a need for a solvent system which does not interfere with the dye layer yet provides adequate viscosity and acceptable drying times.

### SUMMARY OF THE INVENTION

According to the invention there is provided an ink composition comprising a near infrared absorbing dye that converts absorbed near infrared radiation into heat without fluorescing significantly and a substantially non-aqueous, organic solvent system. The dye is selected from the group consisting of a tetrakis (dialkylaminophenyl) aminium dye coupled with one anion, a cyanine and a squarylium. The non-aqueous, organic solvent system comprises an alcohol, wherein said alcohol is selected from the group consisting of diacetone alcohol, 1-methoxy-2-propanol, and combinations thereof.

The method of treating thermoplastic according to the invention comprises (a) providing a near infrared absorbing dye that converts absorbed NIR radiation into heat without fluorescing significantly; (b) dissolving the dye into a substantially non-aqueous, organic solvent to form an ink composition; and (c) contacting a thermoplastic part with the ink composition. The contacting step may include painting, dry-burnishing, dip-coating, spraying, or printing, particularly ink jet printing. The thermoplastic material is selected from the group consisting of polyesters, polyamides, polyolefins, polyurethanes and polycarbonate, for example. Prior to said contacting step (c), the method may include pre-treating the thermoplastic to render it compatible with the ink composition, whereby the ink composition layer will be deposited more uniformly or the ink layer will adhere more strongly to the thermoplastic. Such pre-treatment may include subjecting the thermoplastic to a corona discharge. The dye and solvent used with the method are those described above in connection with the ink composition.

### DETAILED DESCRIPTION OF THE PREFERRED EMBODIMENTS

Ink jet inks are formulated to avoid drying out and clogging the nozzles, yet allow the ink to dry almost immediately upon printing. Furthermore, the formulations must have certain mechanical properties to function in a drop-on-demand printing environment while maintaining their shape without bleeding once fired. Generally, the ink formulations must meet similar requirements whether they incorporate colored dyes or anti-counterfeiting infrared dyes that fluoresce upon infrared irradiation. Apparently, thickeners used as viscosity adjusters, wetting agents, binders, resins, electrolytes as ionic strength modifiers, humectants, and other aqueous-based solvents and additives do not interfere with the fluorescing phenomenon of infrared dyes.

Numerous competing factors must be balanced in developing an ink formulation. The prior art teaches the use of additives to optimize these factors. Generally, these additives do not adversely impact the performance of colored or infrared dyes used in applications requiring fluorescence. An exemplary list of these factors and their interdependence follows:

1. The solubility of the NIR dyes is a factor in determining which solvents may be used.

2. The boiling point of the solvent affects it evaporation rate.

3. A lower evaporation rate favors increased print head dwell time, while a higher evaporation rate favors reduced drying time once printed.

4. The viscosity of the ink is a factor in determining print head compatibility and faceplate wetting.

5. The surface tension of the ink is a factor in determining print head compatibility and faceplate wetting.

6. The viscosity and surface tension affect the upper limit of the firing frequency which also effects faceplate wetting.

Attempts have been made to formulate jet inks with infrared dyes that differ from the anti-counterfeiting dyes in that they primarily convert infrared radiation into heat via vibrational relaxation, e.g. for through transmission welding applications. However, the additives used to adjust the mechanical properties of the ink cause undesirable heat sinking and setting up too high of a printed dot profile resulting in non-welds. Even aqueous-based solvents and water-soluble additives were unusable because more than trace amounts or ambient amounts of water drastically reduce the solubility of the infrared dyes. Accordingly, the challenge was to develop an NIR ink for industrial applications that satisfactorily meet at least all of the above factors without the use of additives.

Solubility Testing—A group of representative broad band near infrared (NIR) absorber dyes were tested for solubility in standard aqueous-based or aqueous containing ink jet solvent systems. The presence of water so reduced the solubility of the dyes that it was determined that a substantially non-aqueous solvent system was needed.

The group of representative broad band NIR dyes was then tested for solubility in butyl lactate, ethyl lactate, DAA, MeO Prop, and Dowanol PMA. The test involved 0.1 gram of the dye added to 9.9 grams of the solvent. The mixture was shaken. In those instances where the solid was not completely dissolved, the mixture was subject to ultrasonic mixing for one-half hour and subsequently, stirring for one-half hour under the application of modest heat. All tested solvents failed to completely dissolve following shaking, ultrasonic mixing and heated stirring, except for the DAA.

Physical Properties Test—The NIR dye and DAA formulation registered viscosity below the print head specifications and registered surface tension within print head specifications.

Printer Test—A solid band of print, 7 mm high, was printed onto polycarbonate and onto paper. The polycarbonate samples showed some movement of ink on the surface, running and spreading, due to low viscosity and slow drying time, which was found to be in excess of five minutes. A recorded dwell time of over 30 minutes was considered acceptable. Continuous printing tests at 1.44 and 4.00 kHz showed that visible faceplate wetting at the higher frequency resulted in a loss of operation of over 90% of the nozzles.

Solvent Modifications—Lower frequency nozzle firing reduces the rate at which ink is delivered to the substrate, suggesting the need for higher dye loading which would also provide the needed increase in viscosity. In addition, a faster drying time was required, however, the addition of lower boiling point solvents would tend to adversely affect dwell time, and solvency. The lower boiling point solvents would also reduce viscosity further out of range and reduce surface tension out of range.

Surprisingly, applicants discovered that by adding one-third part MeO Prop to the solvent system, the higher frequency operated successfully despite the lower viscosity. At the higher frequency, dye loading could be reduced thereby compensating for reduced levels of solvency. Dwell time remained at acceptable levels with drying time being reduced 2-3 fold to less than two minutes.

Ink Formulation—Non-aqueous, preferably alcohol-based, solvents are specified. While diacetone alcohol alone is acceptable, adding up to 40% of 1-methoxy-2-propanol is preferred.

Useful dyes constitute cyanine, squarylium, and preferably tetrakis (dialkylaminophenyl) aminium.

The tetrakis (dialkylaminophenyl) aminium dye may be represented by the following structure:

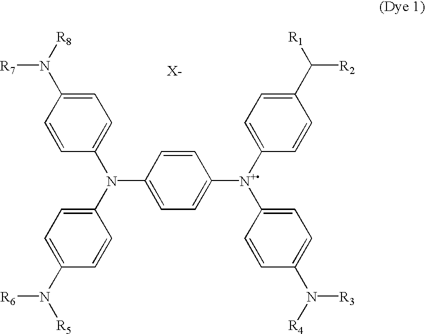

wherein:

R₁ through R₈ each independently represent a substituted or unsubstituted alkyl group of 1 to 8 carbon atoms; and

X⁻ represents an anion.

Particularly useful forms constitute R₁ through R₈ each independently representing a methyl, ethyl, propyl or butyl group. More particularly, R₁ through R₈ may each independently represent an n-propyl or i-propyl group; or an n-butyl, i-butyl, or t-butyl group.

Optionally, R₁ and R₂ join to form a ring, or R₃ and R₄ join to form a ring, or R₅ and R₆ join to form a ring, or R₇ and R8 join to form a ring.

The anion X⁻ represents hexafluoroantimonate (anion 1), hexafluorophosphate (anion 2), hexafluoroarsenate (anion 3), perchlorate (anion 4) or tetrafluoroborate (anion 5), having the following structures:

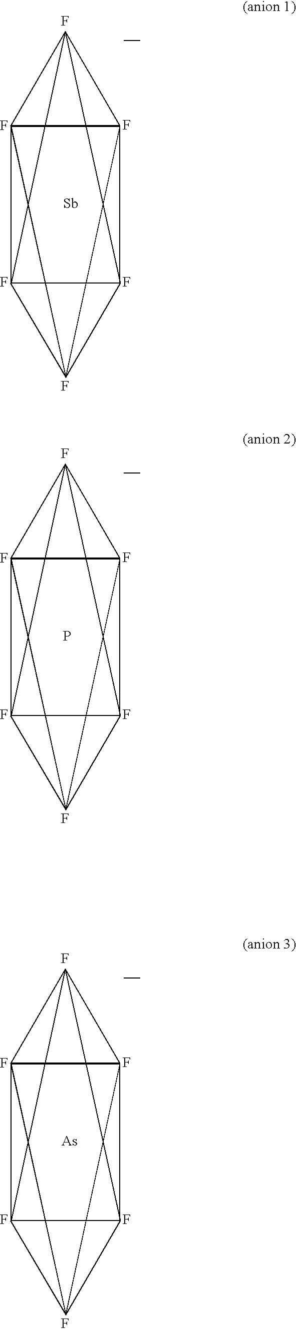

The novel ink formulation may be applied to a number of different types of thermoplastics for through transmission laser welding applications, for example, polyesters, polyamides, polyolefins, polyurethanes, and especially polycarbonates. For polycarbonate select fluorine-containing anions, preferably hexafluorophosphate with n-propyl in the R₁ through R₈ positions. The ink formulation may be applied by any manual, automated or industrial application method, for example, painting, dry-burnishing, dip-coating, spraying, printing, or pad printing. Ink jet printing is of particular utility due to the ability to alter the print pattern for each piece without retooling.

The novel formulation according to the invention shows that the heretofore required thickeners used as viscosity adjusters, wetting agents, binders, resins, electrolytes as ionic strength modifiers, humectants, and other aqueous-based solvents and additives could be eliminated. Applicants discovered that by carefully selecting an infrared dye based on molecular weight as a gross measure of solubility and matching it with one or more substantially non-aqueous solvents, that a jet ink having mechanical properties within workable limits could be formulated.

In this application, a dye which does not “fluoresce significantly” means a dye having as its predominant deactivation process, vibrational relaxation. When such a dye absorbs NIR radiation, the molecule passes from the zero vibrational level of the S₁ state into a high vibrational level of the S₀ state, and then undergoes rapid vibrational relaxation (ca. 10⁻¹³ seconds) to the lowest vibrational level of S₀, with the excess thermal energy being transferred to the surrounding host molecules. Such a dye may fluoresce to a small degree.

We have described and pointed out fundamental novel features of the invention as applied to preferred embodiments thereof. It will be understood that various omissions and substitutions and changes in the form and composition of the formulations and methods described, may be made by those skilled in the art without departing from the spirit of the invention. For example, it is expressly intended that all combinations of those dyes, solvents and/or method steps and/or substrate materials which perform substantially the same function in substantially the same way to achieve the same results are within the scope of the invention. Moreover, it should be recognized that any disclosed form or embodiment of the invention may be incorporated in any other disclosed or described or suggested form or as a general matter of chemical compatibility of application method. It is the intention, therefore, to be limited only as indicated by the scope of the claims appended hereto.

What is claimed is:

1. An ink composition comprising a near infrared absorbing dye that converts absorbed near infrared radiation into heat without fluorescing significantly and a substantially non-aqueous, organic solvent system.

2. The ink composition of claim 1, wherein said dye is selected from the group consisting of a tetrakis (dialkylaminophenyl) aminium dye, a cyanine and a squarylium.

3. The ink composition of claim 1, wherein said non-aqueous, organic solvent system comprises an alcohol.

4. The ink composition of claim 3, wherein said dye comprises a tetrakis (dialkylaminophenyl) aminium dye.

5. The ink composition of claim 3, wherein said alcohol is selected from the group consisting of diacetone alcohol, 1-methoxy-2-propanol, and combinations thereof.

6. The ink composition of claim 5, wherein said solvent system includes 1-methoxy-2-propanol.

7. The ink composition of claim 1, wherein said solvent system includes diacetone alcohol.

8. The ink composition of claim 3, wherein said non-aqueous solvent comprises about 40% or less by weight of 1-methoxy-2-propanol.

9. The ink composition of claim 8, wherein said non-aqueous solvent system further comprises about 60% or more by weight of 4-hydroxy-4-methyl-2-pentanone and wherein said dye comprises a tetrakis (dialkylaminophenyl) aminium dye.

10. The ink composition of claim 1, wherein said dye comprises N,N-Bis(4-dialkylaminophenyl)-N-[4-(N,N-bis(4-dialkylaminophenyl)-amino)phenyl]aminium coupled with one anion.

11. The ink composition of claim 1, wherein said dye may be represented by the following structure: 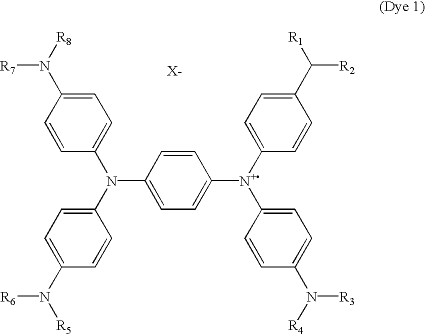
wherein:
R₁ through R₈ each independently represent a substituted or unsubstituted alkyl group of 1 to 8 carbon atoms; and
X⁻ represents an anion.

12. The ink composition of claim 11, wherein R₁ and R₂ join to form a ring, or R₃ and R₄ join to form a ring, or R₅ and R₆ join to form a ring, or R₇ and R₈ join to form a ring.

13. The ink composition of claim 11, wherein R₁ through R₈ each independently represent a methyl, ethyl, propyl or butyl group.

14. The ink composition of claim 11, wherein R₁ through R₈ each independently represent an n-propyl or i-propyl group.

15. The ink composition of claim 11, wherein R₁ through R₈ each independently represent an n-butyl, i-butyl, or t-butyl group.

16. The ink composition of claim 11, wherein X⁻ represents hexafluoroantimonate, hexafluorophosphate, hexafluoroarsenate, perchlorate or tetrafluoroborate.

17. The ink composition of claim 11, wherein R₁ through R₈ represent n-propyl and X⁻ represents hexafluorophosphate.

18. A method of treating thermoplastic comprising the steps of:
(a) providing a near infrared absorbing dye that converts absorbed NIR radiation into heat without fluorescing significantly;
(b) dissolving the dye into a substantially non-aqueous, organic solvent to form an ink composition; and
(c) contacting a thermoplastic part with the ink composition.

19. The method of claim 18, wherein said contacting step (c) comprises painting the ink composition onto the thermoplastic part.

20. The method of claim 18, wherein said contacting step (c) comprises dry-burnishing the ink composition onto the thermoplastic part.

21. The method of claim 18, wherein said contacting step (c) comprises dip-coating the thermoplastic part with the ink composition.

22. The method of claim 18, wherein said contacting step (c) comprises spraying the ink composition onto the thermoplastic part.

23. The method of claim 18, wherein said contacting step (c) comprises printing the ink composition onto the thermoplastic part.

24. The method of claim 18, wherein said non-aqueous, organic solvent comprises an alcohol.

25. The method of claim 24, wherein said dye is selected from the group consisting of a tetrakis (dialkylaminophenyl) aminium dye, a cyanine and a sqarylium.

26. The method of claim 24, wherein said alcohol is selected from the group consisting of diacetone alcohol, 1-methoxy-2-propanol, and combinations thereof.

27. The method of claim 26, wherein said dye comprises a tetrakis (dialkylaminophenyl) aminium dye.

28. The method of claim 18, wherein said dye may be represented by the following structure: 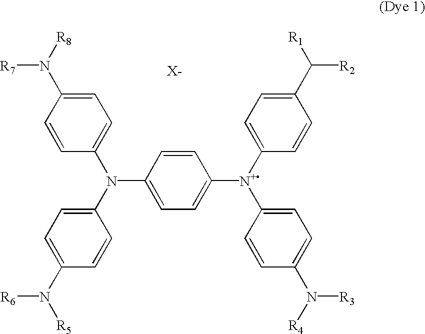
wherein:
R₁ through R₈ each independently represent a substituted or unsubstituted alkyl group of 1 to 8 carbon atoms; and
X⁻ represents an anion.

29. The method of claim 28, wherein X⁻ represents hexafluoroantimonate, hexafluorophosphate, hexafluoroarsenate, perchlorate or tetrafluoroborate.

30. The method of claim 18, wherein said contacting step (c) comprises ink jet printing the ink composition onto the thermoplastic part.

31. The method of claim 30, wherein said non-aqueous, organic solvent system comprises an alcohol.

32. The method of claim 31, wherein said dye is selected from the group consisting of a tetrakis (dialkylaminophenyl) aminium dye, a cyanine and a squarylium.

33. The method of claim 31, wherein said alcohol is selected from the group consisting of diacetone alcohol, 1-methoxy-2-propanol, and combinations thereof.

34. The method of claim 33, wherein said dye comprises a tetrakis (dialkylaminophenyl) aminium dye.

35. The method of claim 33, wherein said dye may be represented by the following structure: 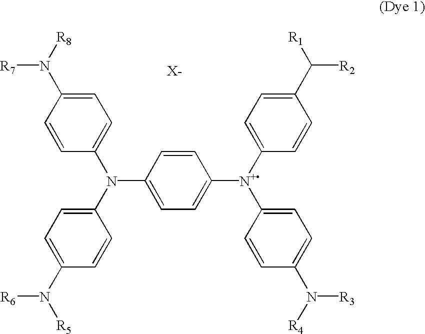
wherein:
R₁ through R₈ each independently represent a substituted or unsubstituted alkyl group of 1 to 8 carbon atoms; and
X⁻ represents an anion.

36. The method of claim 35, wherein X⁻ represents hexafluoroantimonate, hexafluorophosphate, hexafluoroarsenate, perchlorate or tetrafluoroborate.

37. The method of claim 18, wherein the thermoplastic part is made from a material selected from the group consisting of polyesters, polyamides, polyolefins, and polyurethanes.

38. The method of claim 26, wherein the thermoplastic part is made from a material selected from the group consisting of polyesters, polyamides, polyolefins, and polyurethanes.

39. The method of claim 27, wherein the thermoplastic part is made from a material selected from the group consisting of polyesters, polyamides, polyolefins, and polyurethanes.

40. The method of claim 18, wherein the thermoplastic part is made from polycarbonate.

41. The method of claim 28, wherein the thermoplastic part is made from polycarbonate.

42. The method of claim 33, wherein the thermoplastic part is made from polycarbonate.

43. The method of claim 41, wherein said alcohol is selected from the group consisting of diacetone alcohol, 1-methoxy-2-propanol, and combinations thereof.

44. The method of claim 43, wherein R₁ through R₈ represent n-propyl and X⁻ represents hexafluorophosphate.

45. The method of claim 43, wherein X⁻ represents an anion containing fluorine.

46. The method of claim 18, wherein prior to said contacting step (c), the method comprises the additional step of:
pre-treating said thermoplastic part to render the thermoplastic compatible with the ink composition.

47. The method of claim 46, wherein said pre-treating step improves the uniformity of an ink composition layer deposited during said contacting step (c).

48. The method of claim 47, wherein said pre-treating step increases the adherence of the ink composition layer to the thermoplastic.

49. The method of claim 46, wherein said pre-treating step comprises subjecting said thermoplastic part to a corona discharge.
